(19) United States
(12) Patent Application Publication
(10) Pub. No.: US 2018/0326695 A1
(43) Pub. Date: Nov. 15, 2018

(54) A FLOORING PANEL AND METHODS FOR MANUFACTURING SAME

(71) Applicant: AFI LICENSING LLC, Lancaster, PA (US)

(72) Inventors: Melissa A. Kroll, Mount Joy, PA (US); Elizabett A. Malkowski, Lancaster, PA (US); Kim M. Reese, Denver, PA (US)

(21) Appl. No.: 15/753,202

(22) PCT Filed: Jul. 5, 2016
(86) PCT No.: PCT/US2016/040941

§ 371 Date: Feb. 16, 2018

Related U.S. Application Data
(60) Provisional application No. 62/187,892, filed on Jul. 2, 2015.

(51) Int. Cl. B32B 3/30; B32B 38/00; B32B 37/20; B32B 38/06; B32B 3/06; B41M 1/10; E04F 15/02; E04F 15/10

(52) U.S. Cl. CPC B32B 3/30; B32B 38/145; B32B 37/203; B32B 38/0004; B32B 38/06; E04F 2201/023; B41M 1/10; E04F 15/02038; E04F 15/107; B32B 2419/04; B32B 3/06

(57) ABSTRACT

The present invention is directed to a floor panel that is processed on roll equipment, whereby a decorative design consisting of elongated striations is printed with the elongated striations oriented in an across-machine direction. The decorative design is printed on a print layer and is subsequently laminated to a substrate layer. The laminated flooring material is then cut such that the elongate sides of the panels are cut in the across machine direction. This results in a floor panel with greater dimensional stability on the elongate side.

### CROSS-REFERENCE TO RELATED APPLICATIONS

This application claims the benefit of U.S. Provisional Application No. 62/187,892, filed on Jul. 2, 2015. The disclosure of the above application is incorporated herein by reference.

### BACKGROUND

Flooring systems constructed of vinyl and other materials are known in the art. Flooring systems constructed of a number of vinyl panels are known as luxury vinyl tile, or LVT. Flooring systems generally have a decorative pattern on the visible surface to provide an aesthetically pleasing appearance. Recently, attempts have been made to improve the variety of decorative patterns, the image quality of the decorative patterns, and other factors which improve the aesthetic value of the flooring system.

### BRIEF SUMMARY

The present invention is directed to a floor panel that is processed on roll equipment, whereby a decorative design consisting of striated lines is printed with the striations oriented in an across-machine direction. In certain embodiments, the decorative design is printed on a print layer and is subsequently laminated to a substrate layer. In certain embodiments, printing the striations in the across-machine direction may result in a panel with greater dimensional stability of the floor panels in the direction of the striated lines than in the direction orthogonal to the striated lines. In certain embodiments, the print layer may be a vinyl print layer. The invention is further directed to a method of printing a decorative design consisting of striated lines in an across-machine direction and a method of forming a panel with a decorative design oriented in the across-machine direction. Thus, in one embodiment, the invention is a floor panel with striated lines printed in the across machine direction to yield optimum dimensional stability in the direction of the striated lines.

In one embodiment, the invention can be a panel comprising: a first edge, a second edge opposite the first edge, a third edge, and a fourth edge opposite the third edge, each of the first, second, third, and fourth edges defining a portion of a perimeter of the panel; a first dimensional stability in an across-machine direction, the across-machine direction extending from the first edge to the second edge; a second dimensional stability in a machine direction, the machine direction extending from the third edge to the fourth edge and orthogonal to the across-machine direction, the first dimensional stability being greater than the second dimensional stability; a substrate layer; and a print layer atop the substrate layer comprising a visible design comprising elongated striations extending from the first edge to the second edge.

In another embodiment, the invention can be a method of printing a grain design onto a sheet material, the method comprising: providing a roll of the sheet material; feeding the sheet material through a printing station in a machine direction, the printing station comprising an ink reservoir and an engraved cylinder, the engraved cylinder rotatable about a cylinder axis that is oriented in an across-machine direction that is orthogonal to the machine direction, the engraved cylinder comprising a plurality of cells arranged in a pattern that corresponds to the grain design, the cells comprising a plurality of first cells that collectively define an engraved line feature extending axially along a surface of the engraved cylinder; and the cells of the engraved cylinder transferring ink from the ink well to a surface of the sheet material to create the grain design on the surface of the sheet material, the engraved line feature creating an elongated striation of the grain design that extends across the surface of the sheet material in the across-machine direction, and where in the elongated striation has a length measured in the across-machine direction and the sheet material has a width measured in the across-machine direction, the length of the elongated striation being at least one-half of the width of the sheet material.

In a further embodiment, the invention can be a method of forming a panel comprising: providing a roll of a first sheet material; feeding the first sheet material through a lamination station in a machine direction, the lamination station comprising a drum and a lamination roller; providing a roll of a second sheet material comprising a print layer comprising a film having a grain design printed thereon, the grain design pattern having a grain direction in an across-machine direction; feeding the second sheet material through the lamination station in the machine direction; laminating the second sheet material to the first sheet material to form a multi-layer sheet in which the grain design pattern is visible; and cutting the multi-layer sheet into a plurality of panels, each of the panels having a length in the across-machine direction and a width in the machine direction, the length of the panel being greater than the width.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a side elevation schematic diagram of an exemplary embodiment of a laminating system according to the present disclosure.

FIG. 2 is a perspective view of an exemplary rotary cutting system according to the present disclosure.

FIG. 3 is a side elevation schematic diagram of an exemplary embodiment of a printing system according to the present disclosure.

FIG. 4 is a perspective view of an exemplary floor tile manufactured according to the present disclosure.

FIG. 5 is a top view of the floor tile of FIG. 4.

FIG. 6 is a perspective view of an engraved cylinder used in the printing system of FIG. 3.

FIG. 7 is a close-up view of the surface of the engraved cylinder of FIG. 6.

### DETAILED DESCRIPTION

The following description of the preferred embodiment(s) is merely exemplary in nature and is in no way intended to limit the invention, its application, or uses.

As used throughout, ranges are used as shorthand for describing each and every value that is within the range. Any value within the range can be selected as the terminus of the range. In addition, all references cited herein are hereby incorporated by referenced in their entireties. In the event of a conflict in a definition in the present disclosure and that of a cited reference, the present disclosure controls.

Unless otherwise specified, all percentages and amounts expressed herein and elsewhere in the specification should be understood to refer to percentages by weight. The amounts given are based on the active weight of the material.

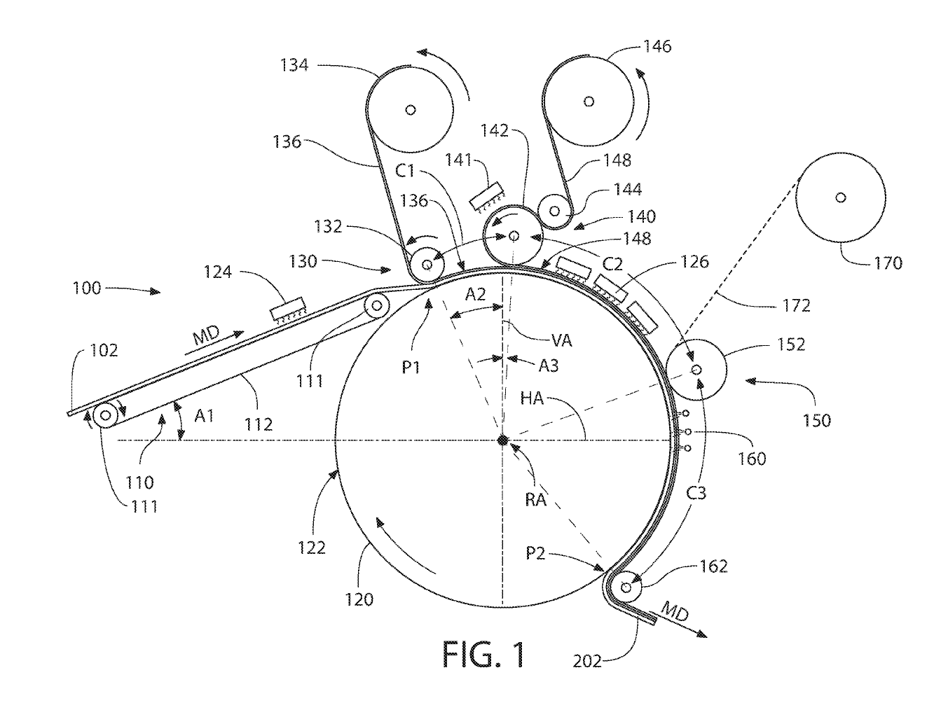

FIG. 1 is a side elevation schematic diagram showing an exemplary embodiment of a continuous laminating system 100 and associated process for producing resilient floor covering products according to the present disclosure. The floor covering product may be a plastic based laminated composition such as a vinyl or non-vinyl thermoplastic composition. In one embodiment, without limitation, the thermoplastic used in the product composition may be PVC. In one embodiment, the floor covering product produced by the laminating system 100 may be luxury vinyl tile (LVT).

It will be appreciated that although the terminology “floor covering product” is used herein without limitation for convenience of description only, such floor covering products produced by the present system and process may be applied to any suitable type and oriented surface including without limitation horizontal, vertical, and/or angled surfaces. Such application surfaces may include floors, walls, countertops, ceilings, and others. Accordingly, products formed according to the present disclosure are not limited in their application or use by the description and terminology used herein.

In one embodiment, laminating system 100 is a drum laminating system. In contrast to conveyor type laminating systems comprising one or more belts and a plurality of belt rollers, various printing, laminating, and embossing operations are performed at different locations spaced along the circumference of a large rotating drum.

Referring to FIG. 1, the laminating system 100 generally includes a mechanical base layer sheet carrier such as belt conveyor 110, a rotating main process drum 120 having a diameter, and one or more laminating stations associated with the drum. The laminating stations may include a print laminating station 130, a wear layer laminating station 140, and an embossing station 150 disposed at different circumferential locations spaced around the drum, as shown and further described herein.

Drum 120 has a circumferential outer surface 122 as shown in FIG. 1. The rotating drum has a rotational axis RA at center which further defines a horizontal reference line HA and vertical reference line VA. Vertical reference line VA is disposed perpendicular or 90 degrees to horizontal reference line HA.

Process drum 120 is a generally cylindrical structure having a suitable diameter and width (measured into the page of FIG. 1) suitable for handling the width of the base layer sheet 102 being laminated. Outer surface 122 provides a rotating working surface for completing printing, laminating, and embossing operations on the composite floor covering product.

The diameter of process drum 120 controls the process speed and throughput of the laminating system 100. The diameter is therefore selected to provide adequate separation between the different stations and time for adhesion of the films on the base layer, heating the laminate to appropriate temperatures during the laminating process, etc. In one exemplary embodiment, without limitation, drum 120 may have a diameter of about 8 feet. Laminating system 100 and associated operating parameters will now further be described below with respect to a process drum 120 having an 8 foot diameter and a linear velocity of outer surface 122 of about 90 feet per minute (fpm). The linear velocity is measured at a point on surface 122 and has a line of action that is perpendicular to a radius line drawn from rotation center RA to the surface.

It will be appreciated that other suitable diameters up to a practical limit of about 12 foot diameter may be used depending on the linear velocity of the outer surface 122 of the rotating drum 120 and corresponding process time intervals necessary to properly complete the various floor covering product formation operations described herein. The linear velocity of outer surface 122 used in some exemplary embodiments is from about 80 to 100 fpm to optimize the drum size and processing time intervals.

Referring to FIG. 1, a base layer sheet 102 is initially provided as a starter material for the lamination process. The base layer sheet 102 may also be known as a substrate layer or a first layer and is formed as a sheet material. Base layer sheet 102 may be spooled on a roll or bolt for convenience. Base layer sheet 102 may be any thermoplastic-based composition or mixture suitable for producing resilient laminated flooring. In one embodiment, sheet 102 is a vinyl composition such as without limitation PVC mixed with fillers, plasticizers, binders, stabilizers, and/or pigments.

Base layer sheet 102 may be any suitable thickness depending on the final floor covering product to be produced. Base layer sheet 102 may generally have a representative gauge or thickness ranging from about and including 40 mils (thousandths of an inch) to about and including 250 mils. In some exemplary embodiments, base layer sheet 102 may have a thickness from about 100 mils to about 145 mils for LVT products.

With continuing reference to FIG. 1, base layer sheet 102 is first loaded onto conveyor 110. In one embodiment, conveyor 110 may be a belt type conveyor comprised of two or more rollers 111 and a continuous loop circulating belt 112 (circulating clockwise in the figure shown). In representative embodiments, the belt may be made a steel mesh.

Base layer sheet 102 is heated on conveyor 110 to a temperature above ambient of about 300-360 degrees F. in exemplary embodiments. Any suitable type process heaters may be used. An example of suitable heaters include radiant surface heaters 124 such as Radplane® Series Rapid Response Electric Infrared Heaters commercially available from Glenro Inc. of Paterson, N.J. The radiant heaters 124 may be suspended above and proximate to conveyor belt 112. One or several heating units may be provided and arranged as necessary to achieve the desired temperature, as will be known to those skilled in the art. Alternatively, one or more heated rollers 111 (e.g. electric, heated oil, etc.) may be used such as those commercially available from American Roller Company of Union Grove, Wis. The heated rollers may be used alone or in conjunction with radiant surface heaters. Adjustable heater controls are provided which are configured to regulate the heat output from either type heater used and maintain the temperature of the base layer sheet 102 within the desired range.

Next, base layer sheet 102 is transferred from conveyor 110 onto circumferential outer surface 122 of rotating process drum 120 as shown in FIG. 1. The direction of travel of the base layer sheet 102 is known as the machine direction MD. In one embodiment, base layer sheet 102 is preferably transferred onto an upper portion of surface 122 (i.e. lying above horizontal reference line HA). In one embodiment, conveyor 110 may be oriented with respect to the process drum 120 to deliver base layer sheet 102 tangentially onto the outer surface 122 of the drum as shown in FIG. 1. In one embodiment, conveyor 110 is obliquely oriented at an angle A1 with respect to horizontal reference line HA of the drum for that purpose. Angle A1 may be from about 1 to 90 degrees, preferably about 30 to 60 degrees in the embodiment shown. In an alternative embodiment, conveyor 110 may be horizontal and disposed at an angle A1 of 0 degrees similar to the arrangement shown U.S. Pat. No. 4,804,429, which is incorporated herein by reference in its entirety.

In one embodiment and arrangement, as shown in FIG. 1, a bottom surface of base layer sheet 102 may engage outer surface 122 of drum 120 at an initial contact point P1 that is laterally offset from vertical reference line VA by an angle A2. The contact point may be disposed at an angle A2 measured with respect to vertical reference line VA that is about 20 degrees from vertical. Other suitable angular offset from vertical may be used.

In one embodiment, the outer surface 122 of the drum is maintained at a temperature between 200 and 230 degree F. such that heated base layer sheet 102 temporarily adheres to the outer surface 122. Drum 120 may formed of a material that is operable to provide temperature controlled adherence and release of a base layer sheet 102 based on hot stick adherence and cold release principles, as will be well known to those skilled in the art. Vinyl-based products exhibit such characteristics and facilitates adherence of base layer sheet 102 to drum 120 for processing and lamination. In one embodiment, drum 120 may be made of steel and outer surface 122 may be chrome plated to provide a smooth surface.

With continuing reference to FIG. 1, the first laminating station encountered by base layer sheet 102 is print laminating station 130 located at the initial contact point P1 of the base layer sheet with the drum 120. Print laminating station 130, which may be a laminating station in one embodiment, includes a laminating assembly comprised of a single roller 132 spaced apart from and in relatively close proximity to drum 120 thereby forming a gap or nip therebetween through which base layer sheet 102 passes. A print layer 136 composed of vinyl or other sheet material having a pattern or design imprinted thereon is fed from a supply spool or roll 134 through the nip concurrently with base layer sheet 102. The print layer 136 is a second layer that is adhered and laminated onto the top surface of the base layer sheet 102 by the heat and laminating pressure applied by the roller 132.

It should be noted that base layer sheet 102 is already heated above ambient conditions on conveyor 110 before reaching the print laminating station 130 (e.g. about 300-360 degrees F. in exemplary embodiments) as already described. Accordingly, roller 132 may be unheated in one embodiment as the already elevated temperature of the base layer sheet 102 is sufficient to adhere the print layer 136 onto the base layer sheet upon contact.

The second laminating station encountered by base layer sheet 102 is wear layer laminating station 140 where a wear layer film 148 is laminated via heat and pressure onto the base layer sheet composite. Laminating station 140 includes a laminating assembly comprised of at least one laminating roller 142 spaced apart from and in relatively close proximity to drum 120 forming a nip therebetween through which base layer sheet 102 with adhered pattern film 136 passes concurrently with wear layer film 148. Laminating roller 142 draws wear layer film 148 from supply spool or roll 146. Laminating roller 142 may have a generally smooth outer surface which contacts the wear layer film. In some embodiments, a second reverse roller 144 may be provided between the supply roll 146 and laminating roller 142 to facilitate wear layer film 148 to be properly placed on laminating roller 142 and to create suitable film tension to prevent wrinkling of wear layer film 148 before lamination to base layer sheet 102.

In one exemplary embodiment and arrangement, laminating roller 142 may be located at an angle A3 measured with respect to vertical reference line VA that is about 6 degrees from vertical.

Wear layer laminating station 140 is spaced apart from print laminating station 130 by an arcuate circumferential distance C1 measured along outer surface 122 of process drum 120 that is sufficient to allow the print layer 136 to adhere sufficiently to base layer sheet 120 before laminating the wear layer film 148. In one exemplary embodiment, without limitation, circumferential distance C1 may be about 2 feet at a corresponding linear surface velocity or speed of 90 fpm of drum surface 122 to provide a time period of about 1.3 seconds for the print layer 136 to adhere to the base layer sheet before lamination of the wear layer film 148.

In some embodiments, the wear layer film 140 is a rigid vinyl film (RVF) having a thickness of at least 15 mils or more to provide a durable and long lasting wear layer for protecting base layer sheet 102. Exemplary embodiments may have a desired RVF thickness of about 20-40 mils which are suitable for LVT commercial application to provide satisfactory wear resistance performance to withstand heavy foot and other traffic. In one embodiment, a 20 mil RVF wear layer may be used. Semi-rigid vinyl films (Semi-RVF), which film composition contains a plasticizer, may also be used in the present process. Utilizing a semi-RVF may require additional post-product annealing steps to impart proper dimensional stability to the vinyl tile.

The wear layer film 148 may be preheated to a predetermined temperature by any suitable method used in the art, including without limitation providing a heated roller 142 (e.g. electric, heated oil, etc.) and/or radiant surface heaters 141 similar to heaters 124 mounted proximate to film 148, such as those already described herein and above. In one exemplary embodiment, a heated roller is used. Reverse roller 144 may be unheated. Adjustable heater controls are provided to regulate the heat output from either type heater used and maintain the preheat temperature of the wear layer film 148 to the desired temperature.

In some configurations of the laminating system 100, the print laminating station 130 and wear layer laminating station 140 operations may be combined into a single laminating station instead of being performed separately on drum 120. Accordingly, laminating station 140 may preheat the wear layer film 148 and then combine and laminate the wear layer film 148 and print layer 136 to base layer sheet 102 via laminating roller 142 in a single step. The feed of print layer 136 from supply roll 134 may be directed to roller 142 instead of roller 132 (see FIG. 1) and combined with wear layer film 148 after heating the wear layer. The heated laminating steps of the invention that uses two mating rollers provides an improved gage, i.e., thickness, control of the resulting laminate and improves the surface of the laminate by pressing and spreading out surface imperfections that may be present on the wear layer film and the base layer sheet.

With continuing reference to FIG. 1, after lamination of the wear layer film 148 onto the base layer sheet 102, the multilayer laminate or composite continues to travel on process drum 120 (clockwise direction in this figure) towards the embossing station 150.

According to another aspect of the present invention, heating of the laminate now comprising the base layer sheet 102, print layer 136, and wear layer film 148 continues from the laminating station 140 to the embossing station 150 next encountered on process drum 120 for the embossing to be successful. In one embodiment, the laminate is heated to an elevated temperature prior to embossing so that the embossing temperature in one embodiment is higher than the preheat temperature of the wear layer film 148 at the wear layer laminating station 140. The inventors have discovered that heating the laminate prior to the embossing is beneficial with thicker wear layer films 148 (i.e. 12 mils or higher) to achieve proper depth and definition of the embossed surface features in the laminate.

The laminate may be heated by any suitable method or combination of methods including radiant surface heating, via heat absorbed from the generally hotter bottom base layer sheet 102, or a combination thereof. In one exemplary embodiment, without limitation, radiant surface heating produced by one or more radiant heaters 126 disposed proximate to process drum 120 may be used as illustrated in FIG. 1. The radiant heaters 126 may be infrared heaters as already described herein, or another suitable type surface heater operable to raise the temperature of the laminate prior to embossing.

The embossing station 150 is separated from the wear layer laminating station 140 by an arcuate circumferential distance C2 (see FIG. 1). Distance C2 is preferably long enough to allow the laminate (base layer sheet 102 and wear layer film 148) to be heated from the temperature leaving the nip at roller 142 to a sufficient elevated temperature for proper embossing. For an example using a 20 mil RVF wear layer, the laminate preferably may be heated to a temperature of at least about and including 300 degrees F. at the nip of the embossing roller 152. In one embodiment, the temperature of the laminate is about 320 degrees F. at the embossing roller 152 for proper embossing.

The distance C2 will be based in part on the linear velocity of the surface 122 of the process drum 120 (e.g. fpm) and the heat output (BTUs) of the radiant surface heaters used. Adjustable heater controls are provided to regulate the heat output from radiant heaters 126 to achieve the foregoing laminate temperature desired at the nip of the embossing station 150.

In one representative embodiment, circumferential distance C2 may be about 5 feet at a corresponding linear surface velocity or speed of 90 fpm of drum surface 122 to provide a time period of about 3.3 seconds for heating the laminate before embossing.

Advantageously, it should be noted that preheating the wear layer film 148 at laminating station 140, which can add about 100 degrees F. to the film, reduces the amount of heat which must be added after the application of the wear layer film to substrate, thereby reducing surface heat requirements and dwell time on the drum process. It has been found that the embossing steps of the present continuous drum process with the accompanying embossing roller imparts improved and sharply defined embossed images on the laminate.

The embossed features may include elongated grooves, pores, slits, waves, streaks, cathedrals, and other shapes that emphasize the printed pattern.

In some possible embodiments, a third lamination step may be optionally be performed at embossing station 150 to add pre-embossed, pre-coated, and/or other type films 172 onto wear layer film 148 from a bolt or roll 170 prior to or instead of embossing. If a pre-embossed film or sheet is added, a roller 152 with a smooth outer surface finish in lieu of an embossed roller having an undulating outer surface with the reverse image of the embossing pattern formed thereon may be used.

Following completion of the embossing operation, the laminate floor covering product continues on process drum 120 to a release point P2 associated with a release roller 162 as shown in FIG. 1. Release roller 162 is operable to maintain tension in and contact of the laminate with drum 120 until removal from the drum.

Since the laminate (i.e. base layer sheet 102) temporarily adheres to outer surface 122 of drum 120 via principles of hot stick adhesion and cold release for vinyl based products, the laminate must cooled sufficiently to a release temperature wherein the laminate sheet will no longer adhere to and separate from the drum. In one embodiment, the cooling is provided by a plurality of water sprays 160 positioned proximate to drum 120 which spray water directly onto the laminate product. In addition, the water sprays 160 rapidly cool the exposed surface of the wear layer film below the glass transition temperature of its polymer, thereby imparting dimensional stability to the laminate. The release temperature may vary depending on the composition of the base layer sheet 102 and thickness of the base layer sheet 102 and wear layer film 148.

In order to provide adequate time to cool the laminate for release from process drum 120, release roller 162 is separated from embossing station 150 by an arcuate circumferential distance C3. In one embodiment, C3 is about 5 feet at a corresponding linear velocity of outer surface 122 of about 90 fpm. This provides a dwell time for cooling of about 3.3 seconds.

In the embodiment shown in FIG. 1, the laminating stations and release point P2 are arranged to take advantage of the assistance of gravity for releasing the laminate floor covering product 202 from process drum 120 under the weight of the laminate. Other arrangements, however, are possible.

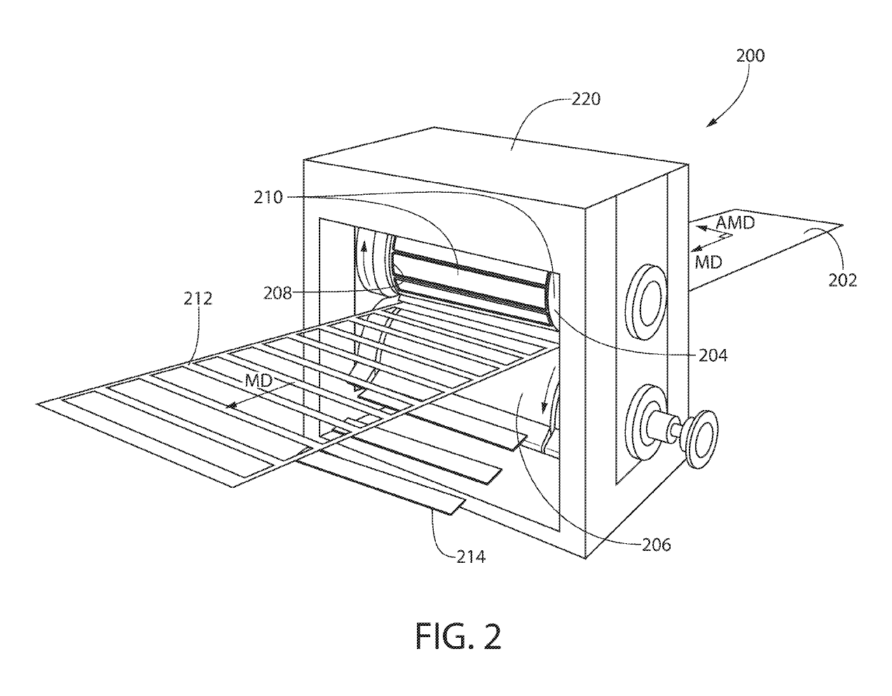

Turning now to FIG. 2, an exemplary rotary die cutting station 200 is disclosed. After the laminate floor covering product 202 exits the process drum 120, it is then fed into the rotary die cutting station 200 in the machine direction MD. When operating in tandem with the laminating system 100, the rotary die cutting station 200 operates at the same speed as the laminating system 100. In alternate embodiments, the rotary die cutting station 200 may be separate from the laminating system, requiring spooling and un-spooling of the laminate floor covering product 202 between the laminating system 100 and the rotary die cutting station 200. In some embodiments, the laminate floor covering product 202 may be annealed before processing in the rotary die cutting station 200.

The rotary die cutting station 200 has a rotary cutter 204 and an impression roller 206. The rotary cutter 204 has a cylindrical shape, with the periphery incorporating a series of raised edges 208 that form the outer diameter of the rotary cutter 204. Adjacent to the raised edges 208 are relief portions 210 that have a reduced diameter as compared with the raised edges 208. The raised edges 208 define the shape to be cut into the laminate floor covering product 202.

The rotary cutter 204 and the impression roller 206 are housed in a machine housing 220. The machine housing 220 rigidly mounts the rotary cutter 204 and the impression roller 206 so that they are able to resist the cutting forces resulting from cutting the laminate floor covering product 202. The rotary cutter 204 and the impression roller 206 are geared to rotate in opposite directions, such that the laminate floor covering product 202 is not required to slide over either the rotary cutter 204 or the impression roller 206 as the laminate floor covering product 202 passes through the rotary die cutting station 200. Further, mechanically connecting the rotary cutter 204 and the impression roller 206 prevents bunching or fouling of the rotary die cutting station 200. If the rotary cutter 204 or the impression roller 206 were left to freewheel, friction between the rotary cutter 204 or the impression roller 206 and the laminate floor covering product 202 may not be sufficient to ensure smooth cutting.

The impression roller 206 and the rotary cutter 204 are spaced apart by a small gap, with this distance being adjustable to control cut parameters. The gap may be adjusted to accommodate different thicknesses of laminate floor covering product 202, ensure a clean cut, or permit multiple different materials and laminate compositions to be processed through the same rotary die cutting station 200.

Panel blanks 214 are cut from the laminate floor covering product 202 as it passes through the rotary die cutting station 200. In the exemplary embodiment, panel blanks 214 have an elongate rectangular shape, with the elongate dimension oriented in the across-machine direction AMD. The panel blanks 214 span substantially the entire width of the laminate floor covering product 202 in the across-machine direction AMD, but may be cut slightly smaller to ensure that the elongate ends of the panel blanks 214 are cut cleanly in the event that the laminate floor covering product 202 has irregularities in the edges of the sheet. The impression roller 206 provides support to the laminate floor covering product 202 as it is cut by the rotary cutter 204.

In other embodiments, the panel blanks 214 may have a square shape, a circular shape, an oval shape, or any other shape. In yet other embodiments, more than one panel blank may be cut from the laminate floor covering product 202 in the across-machine direction AMD. In further embodiments, the edges of adjacent panel blanks 214 may be cut with a single raised edge 208, such that there is no wasted material between adjacent panel blanks 214. The remnants 212 exit the opposite side of the die cutting station 200 and may be recycled or otherwise disposed of.

The rotary die cutting station 200 is exemplary, and other cutting methods may be employed including flatbed die cutting, water jet cutting, laser cutting, or any other technique known in the art. Additional processing operations may be performed on the panel blanks 214 after they have been cut from the laminate floor covering product 202, such as edge finishing or annealing.

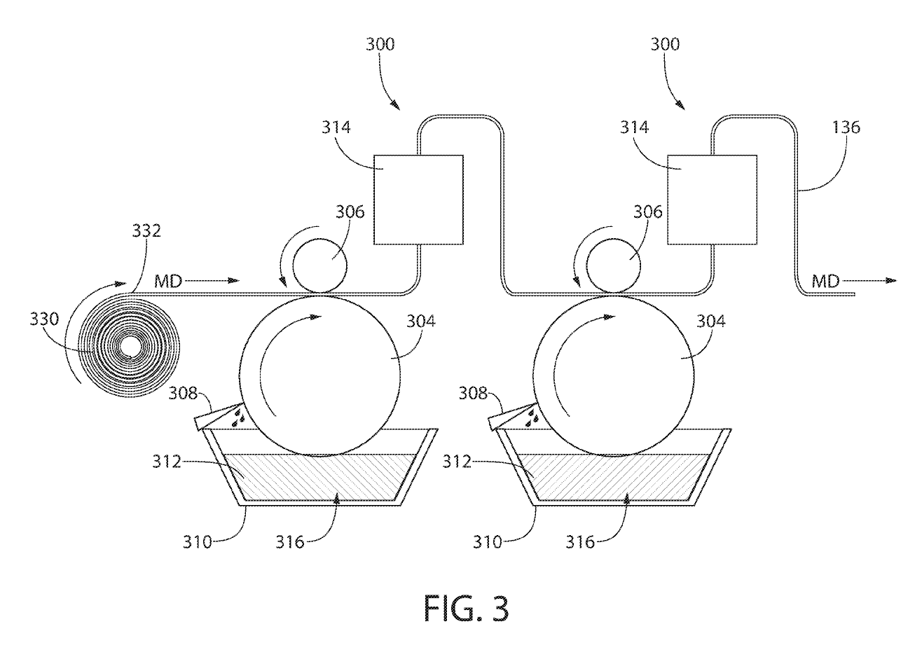

Turning now to FIG. 3, a schematic diagram of a rotogravure printing process for producing the print layer 136 is disclosed. The exemplified rotogravure printing process incorporates two printing stations 300. In other embodiments, only one printing station 300 may be used. In yet other embodiments, there may be more than two printing stations 300. The printing stations 300 each comprise an impression roller 306, an engraved cylinder 304, a doctor blade 308, an ink fountain 310, ink 312, and a dryer 314. A roll of sheet material 330 is provided to the printing stations 300, with the sheet material 332 being fed in a machine direction MD through the printing stations 300.

The sheet material 332 may be composed of any material suitable for rotogravure printing, including paper and other cellulose based materials, thermoplastic material, thermosetting material, or any other suitable material. In one embodiment, the sheet material 332 may be a rigid vinyl film which is white in color. In other embodiments, the sheet material may be a vinyl film mixed with additional fillers, plasticizers, binders, stabilizers, and/or pigments.

The sheet material 332 may be any suitable thickness depending on process requirements, the thickness of the final floor covering material to be produced, or other parameters. The sheet material 332 may have a representative gauge or thickness ranging from about and including 2 mils to about 10 mils. In some exemplary embodiments, the sheet material 332 may have a thickness from about 3 mils to about 5 mils.

The engraved cylinder 304 is rotated as the sheet material 332 is fed in the machine direction MD, transferring ink 312 from an ink reservoir 316 of the ink fountain 310 to the sheet material 332. The ink fountain 310 supplies ink 312 to the engraved cylinder 304, either by pumping the ink 312 upward into contact with the engraved cylinder 304 along the length of the engraved cylinder 304, or by providing ink 312 such that the engraved cylinder 304 is partially submerged. The ink reservoir 316 is the portion of the ink fountain 310 that stores ink 312 before it is applied to the engraved cylinder 304.

As the engraved cylinder 304 is rotated, the portion of the engraved cylinder 304 that was formerly exposed to ink 312 passes the doctor blade 308. The doctor blade 308 is positioned in close proximity to the engraved cylinder, and wipes off excess ink 312. Thus, the engraved cylinder 304 is continuously exposed to ink 312 and excess ink 312 is wiped off by the doctor blade 308. The engraved cylinder 304 then rolls against the sheet material 332 and deposits the ink 312 onto the surface of the sheet material 332.

The engraved cylinder 304 and the impression roller 306 are spaced apart from each other, but in relatively close proximity, such that there is a small gap between the engraved cylinder 304 and the impression roller 306. The sheet material 332 passes through the gap, with the impression roller 306 providing support to the sheet material 332 so that the ink 312 can be deposited onto the sheet material 332. The engraved cylinder 304 and the impression roller 306 rotate in opposite directions to prevent slipping across the sheet material 332, which may have a detrimental impact on print quality, print registration, or damage the sheet material 332.

The ink 312 used in each printing station 300 may be of a variety of colors and chemistries. When wood grain is emulated, colors such as black, brown, red, and shades thereof may be used to achieve realistic results. When stone such as marble or granite are emulated, colors such as blue, black, or gray, and shades thereof may be utilized. The ink 312 may be water based, or comprise another solvent. This solvent may be an organic or an inorganic solvent. In some embodiments, different color inks may have different chemistries.

However, each printing station 300 is limited to one color of ink 312 because the ink fountain 310 can only dispense a single color of ink 312 at a time. Further, the engraved cylinder 304 of the printing station is engraved such that it prints a specific pattern corresponding to a specific color onto the sheet material 332. If the color is interchanged, the print would not be consistent with the intended image.

The sheet material 332 is passed between the impression roller 306 and the engraved cylinder 304, where the ink 312 is deposited on one side of the sheet material 332. After the ink 312 is deposited on the sheet material 332, the sheet material 332 passes through the dryer 314. The dryer 314 dries and cures the ink 312 so that the ink 312 is bonded to the sheet material 332 and cannot be obscured through normal handling. The dryer 314 may be a radiant surface heater such as the ones discussed above. Alternately, convection heaters may be used. The heater may be provided with an adjustable controller to control the heat applied to the sheet material 332 and ensure that the ink 312 is properly cured.

As will be discussed in greater detail below, the engraved cylinder 304 has a design engraved onto the outer surface of the engraved cylinder 304 to permit controlled transfer of ink 312 from the ink fountain 310 to the sheet material 332. Due to the rotation of the engraved cylinder 304, the portion of the engraved cylinder 304 that comes in contact with the ink 312 supplied by the ink fountain 310 has a coating of ink 312 deposited on the outer surface of the engraved cylinder 304. The doctor blade 308 then removes excess ink 312 by a wiping action on the outer surface of the engraved cylinder 304. The excess ink 312 falls back into the ink fountain 310 and may be recycled for later use.

The doctor blade 308 may be of a variety of shapes, and need not have a single pointed edge in contact with the engraved cylinder 304. In alternate embodiments, the doctor blade 308 may have a series of ribs which perform repeated wiping of the engraved cylinder. In other embodiments, the angle of the doctor blade 308 may be adjusted with respect to the engraved cylinder 304 to permit optimization of the wiping action for a particular design and ink 312 combination and improved printing performance.

After the sheet material 332 has been processed through all of the printing stations 300 required by the design, the sheet material 332 exits as a print layer 136. As discussed above, the number of different colors of inks 312 required dictates the number of printing stations 300 required. The print layer 136 may be laminated immediately in a laminating process such as the one described above, or may be spooled in preparation for future use. If desired, the print layer 136 may also be trimmed prior to lamination to remove the edges of the print layer 136 which may not have a complete design printed thereon. This prevents unnecessary waste of the base layer sheet 102 during the post-lamination cutting and trimming steps.

In yet other embodiments, the print layer 136 may be a layer of ink 312 printed directly or indirectly on the base layer sheet 102, which serves as the substrate for the flooring product. Thus, the print layer 136 may be exclusively composed of ink 312, and need not be printed on a separate sheet material 332. Alternately, the print layer 136 may be printed indirectly on the base layer sheet 102 with additional layers interposed therebetween.

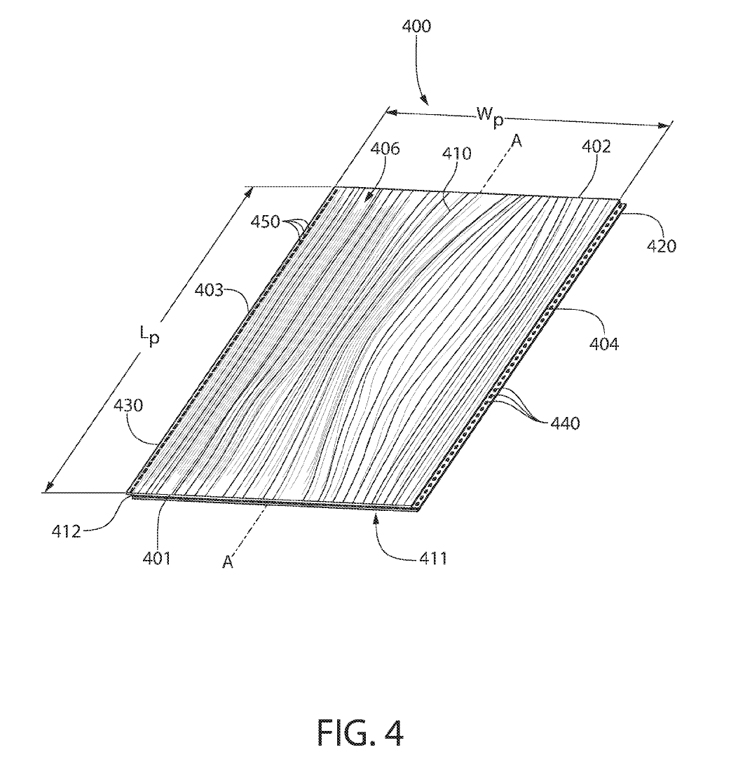

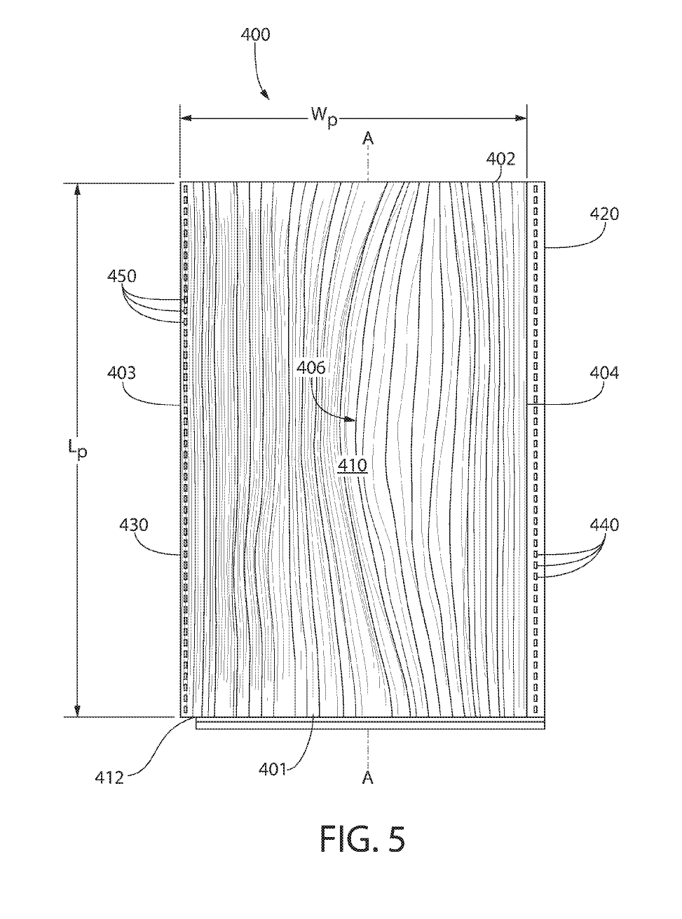

FIGS. 4 and 5 disclose a floor panel 400 manufactured according to an embodiment of the present invention. This floor panel 400 has been processed from the panel blanks 214 discussed above with respect to FIG. 2. While the inventive floor panel 400 is referred to herein as a “floor panel,” it is to be understood that the inventive floor panel 400 can be used to cover other surfaces, such as wall surfaces.

The floor panel 400 generally comprises a top surface 410 and an opposing bottom surface 411. The top surface 410 is visible when the floor panel 400 is installed, and, thus, has a finished surface comprising a visible decorative pattern. The bottom surface 411 is intended to be in surface contact with the surface that is to be covered, such as a top surface of a sub-floor. The term sub-floor, as used herein, is intended to include any surface that is to be covered by the floor panels 100, including without limitation plywood, existing tile, cement board, concrete, wall surfaces, hardwood planks, and combinations thereof. Thus, in certain embodiments, the bottom surface 411 may be an unfinished surface.

The floor panel 400 extends along a longitudinal axis A-A. In the exemplified embodiment, the floor panel 400 has a rectangular shape. In other embodiments of the invention, however, the floor panel 400 may take on other polygonal shapes. The floor panel 400 has a panel length L_{P} measured along the longitudinal axis A-A from a first edge 401 of the top surface 410 to a second edge 402 of the top surface 410. The floor panel 400 also comprises a panel width W_{P} measured from a third edge 403 of the top surface 410 to a fourth edge 404 of the top surface 410 in a direction transverse to the longitudinal axis A-A. In certain such embodiments (such as the exemplified one), the floor panel 400 is an elongated panel such that L_{P} is greater than W_{P}. In other embodiments, however, the floor panel 400 may be a square panel in which L_{P} is substantially equal to W_{P}.

The floor panel 400 generally comprises a body 406, a first flange 420 extending from a fourth edge 404 of the body 406, and a second flange 430 extending from a first undercut edge 412 of the body 406. In the exemplified embodiment, due to the top surface 410 being the intended display surface of the floor panel 400, the first flange 420 may be considered the lower flange while the second flange 430 may be considered the upper flange. In other embodiments, the floor panel 400 may be designed such that the second flange 430 (along with the slots 450) is the lower flange that forms a portion of the bottom surface 411 of the floor panel 400 while the first flange 420 (along with the teeth 440) is the lower flange that forms a portion of the top surface 410.

The third and fourth edges 403, 404 are located on opposite sides of the body 406 and extend substantially parallel to the longitudinal axis A-A. Thus, the first and second flanges 420, 430 extend from opposite lateral sides of the body 410. In the exemplified embodiment, the first flange 420 is a continuous flange that extends along substantially the entire length of the floor panel 400. Similarly, the second flange 430 is also a continuous flange that extends along substantially the entire length of the floor panel 400. In certain embodiments, however, the first and/or second flanges 420, 430 can be discontinuous so as to comprise a plurality of flange segments that are separated by a gap.

In the exemplified embodiment, the first flange 420 of one floor panel 400 overlaps with the second flange 430 of a second floor panel 400 such that the top surfaces 410 of the two floor panels 400 are substantially coplanar. The teeth 440 engage the slots 450 to resist separation between adjacent panels. In certain other embodiments, the first flange 420 and the second flange 430 may take other shapes, including interlocking hook shapes, or any other shape capable of resisting separation between adjacent floor panels 400.

Floor panels 400 are formed from panel blanks 214 as discussed above. The first flange 420 and the second flange 430 are profiled by punching, milling, grinding, and other cutting operations to achieve the desired geometry. In alternate embodiments, the floor panels 400 are configured to interlock so that they are vertically locked or horizontally locked, preventing separation of adjacent panels.

The floor panels 400 may interlock on two edges, four edges, or any other number of edges as desired. Still further embodiments may utilize a shiplap configuration whereby the floor panels 400 overlap and adhesive is used to join the floor panels 400 and prevent adjacent floor panels 400 from separating in the horizontal direction. Additional geometry which prevents floor panels 400 separation in the vertical direction is also within the scope of the invention. Additional flanges may be provided to connect the first and second edges 401, 402.

Alternate examples of edge profiles that may be used include the 5G profile designed by Valinge Innovation AB of Sweden. In yet other embodiments, the panels may have straight edges without an interlocking system, and instead may be adhesively bonded to a subfloor and grouted to provide a finished appearance.

The floor panel 400's longitudinal axis A-A is aligned with the across-machine direction AMD. Similarly, the machine direction MD is transverse to the floor panel 400's longitudinal axis A-A. The floor panel 400 has a first dimensional stability in the across-machine direction AMD, the across-machine direction AMD extending from the first edge 401 to the second edge 402. The machine has a second dimensional stability in the machine direction MD, the machine direction extending from the third edge 403 to the fourth edge 404 and being orthogonal to the across-machine direction AMD.

Without intending to be bound by theory, the inventors have discovered that the processes used to manufacture vinyl based surface coverings result in products having different stress-strain characteristics in the machine direction MD and across-machine direction AMD. In some embodiments, during the lamination process, the sheet is pressed between rollers which results in elongation (and thinning) of the laminate sheet in the machine direction MD, with minimal elongation in the across-machine direction AMD. In other embodiments, the stress/strain characteristics of the sheet are permanently altered in the machine direction MD. While these differences may go unnoticed in certain installations or under certain conditions, they are critical in flooring systems which are exposed to varying environmental conditions.

In some embodiments, dimensional stability is evaluated by resistance to shrinkage. As used herein, “shrinkage” means the extent to which a dimension contracts relative to the entire span of that particular dimension, which may be considered a rate of shrinkage in certain embodiments.

In some embodiments, the first dimensional stability is a first resistance to shrinkage of the floor panel 400 in the length direction and the second dimensional stability is a second resistance to shrinkage of the floor panel 400 in the width direction. The first dimensional stability and the second dimensional stability may be measured by the shrinkage of the floor panel 400 after an annealing process, or may be measured in accordance with ASTM F2199.

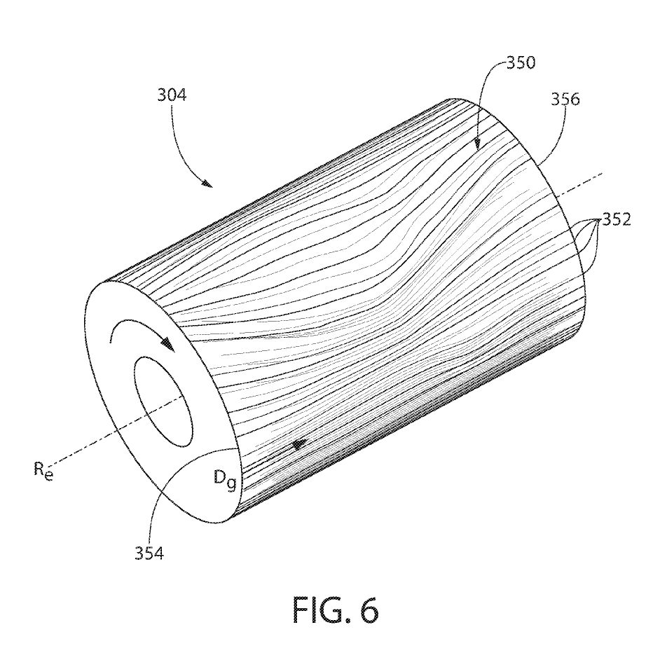

Turning now to FIG. 6, an engraved cylinder 304 of a printing station 300, as disclosed above with respect to FIG. 3 is shown. The engraved cylinder has a printed design 350 engraved on the outer surface 360. The printed design 350 consists of a grain design having a plurality of elongated striations 352. These elongated striations 352 extend from a first edge 354 of the engraved cylinder 304 to a second edge 356 of the engraved cylinder 304, such that they are printed in the across-machine direction AMD. Collectively, the elongated striations 352 define a grain direction D_{g}.

Not all elongated striations 352 need to extend across the full width of the engraved cylinder 304. Further, the engraved cylinder 304 may have a width that is less than the width of the sheet material 332, but to avoid material waste, the engraved cylinder 304 is generally sized such that the width of the engraved cylinder 304 is only slightly shorter than the width of the sheet material 332.

The engraved cylinder 304 rotates about a cylinder axis Rₑ that is aligned with the across-machine direction AMD of the printing station 300. The cylinder axis Rₑ is also perpendicular to the machine direction MD. Thus, when the outer surface 360 is in contact with the sheet material 332, the outer surface 360 does not slide relative to the sheet material 332.

The printed design 350 may take the form of a wood grain pattern, a stone grain pattern, or any other pattern having elongated striations 352. In alternate embodiments, the printed design 350 may have elongated striations 352 arranged perpendicular to the across-machine direction AMD. In still further embodiments, the printed design may not have any elongated striations 352, and may be an ornamental pattern that does not represent any natural material. In yet other embodiments, the printed design may have elongated striations 352 that are arranged at an angle to the across-machine direction AMD. This angle may emulate the slope of the grain on an actual wood plank. In yet other embodiments, the printed design may have elongated striations 352 that simulate cathedrals, mineral streaks, waves, and any other natural features of wood or stone.

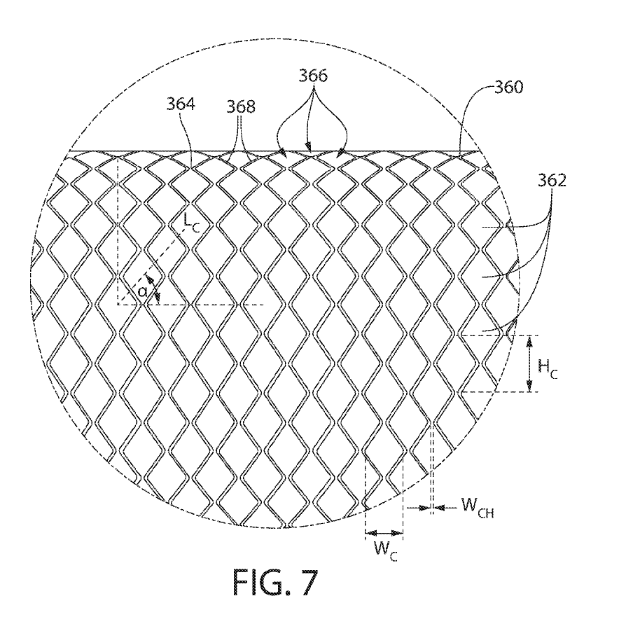

FIG. 7 shows a close-up view of the engraved cylinder 304, showing a plurality of cells 362 which form the printed design 350. FIG. 7 is illustrated such that the circumference of the engraved cylinder 304 is oriented vertically, and the cylinder axis Rₑ is oriented horizontally. Cells 362 form engraved line features which correspond to elongated striations 352 visible to the naked eye.

As is typical of rotogravure printing, cells 362 are formed as a diamond shape, with each cell 362 having a cell width W_{c} and a cell height H_{c}. The diamond shape need not be a square, but instead may be either elongated or compressed, depending on the compression angle α. Due to the diamond shape of the cells 362, adjacent columns 366 of cells 362 are not horizontal, but instead are interleaved, with the cells 362 interlocking along their sloped sides, as can be seen in FIG. 7. The compression angle α is determined by drawing a line L_{c} along the centers of cells 362 in adjacent columns 366, and measuring the angle between this line L_{c} and a horizontal line.

In the exemplary embodiment, the compression angle α is 45 degrees. Reducing the compression angle α results in a compressed cell 362 with a reduced cell height H_{c} and an enlarged cell width W_{c}. Increasing the compression angle α results in an elongated cell 362 with an enlarged cell height H_{c} and a reduced cell width W_{c}. In alternate embodiments, the compression angle α may be between 35 degrees and 55 degrees.

Cells 362 are formed by using a stylus, generally having a diamond tip. The stylus has a point angle which may be varied, and is typically between 105 and 130 degrees. The stylus creates the diamond shape as it cuts into the surface of the engraved cylinder 304, forming a pyramid shaped cavity. Smaller stylus point angles increase the depth of the cell 362 for a given cell width W_{c} and cell height H_{c}, providing a larger volume of the cell 362. In the exemplary embodiment, best results were received with a stylus point angle of 130 degrees.

Cells 362 are separated by walls 368. The walls 368 are portions of the outer surface of the engraved cylinder 304 that have not been removed by the stylus, and separate individual cells 362 from each other. Walls 368 are typically no smaller than 8 μm, but may be 24 μm or larger.

Individual cells 362 may be connected in the vertical direction by channels 364 that connect adjacent cells 362 in each column 366. The channels 364 assist with the flow of ink 312 into the cells 362 as the engraved cylinder 304 is rotated through the ink fountain 312. In the exemplary embodiment, cells 362 are connected by channels 364. In alternate embodiments, the channels 364 may be omitted if the combination of print parameters results in deposition of excessive ink 312. This results in continuous walls 368 encircling each cell 362.

In the exemplary embodiment, the columns 366 of cells 362 are arranged vertically, such that each column 366 has a helix angle of zero. This results in a plurality of columns 366, rather than a continuous helix. In alternate embodiments, the cells 362 may be engraved with a small helix angle, which yields a continuous helix, such that individual columns 366 are actually connected to the columns 366 on either side. Engraved cylinders 304 with the columns 366 arranged vertically yield superior line definition in the vertical direction, which makes them more suitable for providing sharp line definition in the machine direction MD.

Yet another parameter of rotogravure printing is the line screen number, measured in cells per inch along the line L_{c}. The equivalent metric parameter is known as raster number, which is measured in cells per centimeter. Increased line screen number values result in higher density of cells 362. However, this decreases the volume of ink 312 per cell 362. The exemplary embodiment utilizes a line screen number value of 137 (equivalent to a raster of 54), which provides larger cells 362 than are typically used when printing a print layer 136. Typical line screen values for rotogravure printing of print layers 136 used in flooring products range from 150 to 175. In alternate embodiments, line screen values less than 135 or greater than 145 may be used. In yet other embodiments, the line screen number may vary between 125 cells per inch and 145 cells per inch.

As would be apparent to one of skill in the art, the number of cells 362 per inch or centimeter in the horizontal and vertical directions is not the same as the line screen. The compression angle α alters the number of cells 362 per inch or centimeter in the horizontal and vertical directions due to the elongation or compression of the cells 362 with larger or smaller compression angle α values. Further, larger line screen values decrease cell depth because cell width W_{c} and a cell height H_{c} are reduced accordingly.

1. A panel comprising:
a first edge, a second edge opposite the first edge, a third edge, and a fourth edge opposite the third edge, each of the first, second, third and fourth edges defining a portion of a perimeter of the panel;
a first dimensional stability in an across-machine direction, the across machine direction extending from the first edge to the second edge;
a second dimensional stability in a machine direction, the machine direction extending from the third edge to the fourth edge and orthogonal to the across-machine direction, the first dimensional stability being greater than the second dimensional stability;
a substrate layer; and
a print layer atop the substrate layer comprising a visible design comprising elongated striations extending from the first edge to the second edge.

2. The panel according to claim 1 wherein the visible design is a wood grain design having a grain direction defined by the elongated striations.

3. The panel according to claim 1 wherein the visible design is a marble grain design having a grain direction defined by the elongated striations.

4. The panel according to claim 1 wherein the substrate layer is a vinyl layer.

5. The panel according to claim 4 wherein the vinyl layer comprises a filler, a plasticizer, and a vinyl binder.

6. The panel according to claim 1 wherein the print layer comprises a film and ink applied to the film to form the visible design.

7. The panel according to claim 1 further comprising a wear layer atop the print layer.

8. The panel according to claim 1 wherein the first and second dimensional stabilities are determined by ASTM F2199.

9. The panel according to claim 1 wherein the panel is elongated, the panel having a length defined between the first and second edges and a width defined between the third and fourth edges, the length being greater than the width.

10. The panel according to claim 10 wherein a ratio of the length to width is at least 2:1.

11. The panel according to claim 1 further comprising a top surface comprising embossed features comprising elongated grooves extending from the first edge to the second edge.

12. The panel according to claim 1 wherein the first and third edges are configured to interlock with one another; and wherein the third and fourth edges are configured to interlock with one another.

13. A method of roll printing a grain design onto a sheet material, the method comprising:
a) providing a roll of the sheet material;
b) feeding the sheet material through a printing station in a machine direction, the printing station comprising an ink reservoir and an engraved cylinder, the engraved cylinder rotatable about a cylinder axis that is oriented in an across-machine direction that is orthogonal to the machine direction, the engraved cylinder comprising a plurality of cells arranged in a pattern that corresponds to the grain design, the cells comprising a plurality of first cells that collectively define an engraved line feature extending axially along a surface of the engraved cylinder; and
c) the cells of the engraved cylinder transferring ink from the ink well to a surface of the sheet material to create the grain design on the surface of the sheet material, the engraved line feature creating an elongated striation of the grain design that extends across the surface of the sheet material in the across-machine direction, and wherein the elongated striation has a length measured in the across-machine direction and the sheet material has a width measured in the across-machine direction, the length of the elongated striation being at least one-half of the width of the sheet material.

14. The method according to claim 13 wherein the first cells are arranged in a plurality of columns; and wherein for each of the columns, adjacent ones of the first cells in the column are connected to one another by a cell channel that circumferentially extends along the surface of the engraved roller orthogonal to the cylinder axis.

15. The method according to claim 14 wherein the first cells of adjacent ones of the columns are offset from one another in a circumferential direction.

16. The method according to claim 13 wherein the first cells are arranged to have a compression angle that is between 35° and 55°.

17. The method according to claim 13 wherein the first cells are arranged to have a line screen number between 125 cells per inch and 145 cells per inch.

18. The method according to claim 13 wherein each of the first cells are diamond shaped.

19. The method according to claim 18 wherein each of the first cells comprises a major axis and a minor axis, the minor axis extending orthogonal to the cylinder axis.

20. The method according to claim 13 wherein the sheet material is a vinyl film.

21. The method according to claim 13 wherein the grain design is a wood grain design or a marble grain design.

22. The method according to claim 13 wherein the first cells collectively define a plurality of engraved line features that extend axially along the surface of the engraved cylinder; and wherein step c) comprises the cells of the engraved cylinder transferring ink from the ink well to the surface of the sheet material to create the grain design on the surface of the sheet material, the engraved line features creating a plurality of elongated striations of the grain design that extend across the surface of the sheet material in the across-machine direction.

23. A method of forming a panel comprising:
a) providing a roll of a first sheet material;
b) feeding the first sheet material through a lamination station in a first machine direction;
c) providing a roll of a second sheet material comprising a print layer comprising a film having a grain design printed thereon, the grain design pattern having a grain direction in a first across-machine direction;
d) feeding the second sheet material through the lamination station in the first machine direction;
e) laminating, using the lamination station, the second sheet material to the first sheet material to form a multi-layer sheet in which the grain design pattern is visible; and
f) cutting the multi-layer sheet into a plurality of panels using a cutting station, each of the panels having a length in the first across-machine direction and a width in the first machine-direction, the length of the panel being greater than the width.

24. The method according to claim 23 wherein providing the roll of the second sheet material in step c) further comprises:
c-1) feeding the film through a printing station in a second machine direction, the printing station comprising an ink reservoir and an engraved cylinder, the engraved cylinder rotatable about a cylinder axis that is oriented in a second across-machine direction that is orthogonal to the second machine direction, the engraved cylinder comprising a plurality of cells arranged in a pattern that corresponds to the printed grain design, the cells comprising a plurality of first cells that collectively define an engraved line feature extending axially along a surface of the engraved cylinder; and
c-2) the cells of the engraved cylinder transferring ink from the ink well to a surface of the film to create the printed grain design on the surface of the film, the engraved line feature creating an elongated striation of the printed grain design that extends across the surface of the film in the second across-machine direction, and wherein the elongated striation has a length measured in the second across-machine direction and the film has a width measured in the second across-machine direction, the length of the elongated striation being at least one-half of the width of the film.

25. The method according to claim 24 wherein the first cells are arranged in a plurality of columns; and wherein for each of the columns, adjacent ones of the first cells in the column are connected to one another by a cell channel that circumferentially extends along the surface of the engraved roller orthogonal to the cylinder axis.

26. The method according to claim 25 wherein the first cells of adjacent ones of the columns are offset from one another in a circumferential direction.

27. The method according to claim 24 wherein the first cells are arranged to have a compression angle that is between 35° and 55°.

28. The method according to claim 24 wherein the first cells are arranged to have a line screen number between 125 cells per inch and 145 cells per inch.

29. The method according to claim 24 wherein each of the first cells are diamond shaped.

30. The method according to claim 24 wherein the first cells collectively define a plurality of engraved line features that extend axially along the surface of the engraved cylinder; and wherein step c-2) comprises the cells of the engraved cylinder transferring ink from the ink well to the surface of the film to create the printed grain design on the surface of the film, the engraved line features creating a plurality of elongated striations of the printed grain design that extend across the surface of the sheet material in the second across-machine direction.

31. The method according to claim 23 wherein the first sheet material comprises a filler, a plasticizer, and a vinyl binder.

32. The method according to claim 23 wherein the film is a vinyl film.

33. The method according to claim 23 wherein the printed grain design is a wood grain design or a marble grain design.

34. The method according to claim 23 further comprising, subsequent to step e) and prior to step f):
feeding the multi-layer sheet, in the first machine direction, into an embossing station; and
embossing a top surface of the multi-layer sheet.
